(19) United States
(12) Patent Application Publication
(10) Pub. No.: US 2024/0070880 A1
(43) Pub. Date: Feb. 29, 2024

(54) 3D VIRTUAL CONSTRUCT AND USES THEREOF

(71) Applicant: Tracxone Ltd., Nesher (IL)

(72) Inventors: Gidon MOSHKOVITZ, Haifa (IL); Itai WINKLER, Haifa (IL); Uri YAHALOM, Haifa (IL); Moshe MEIDAR, Coral Gables, FL (US)

(73) Assignee: Tracxone Ltd., Nesher (IL)

(21) Appl. No.: 18/259,591

(22) PCT Filed: Dec. 29, 2021
(86) PCT No.: PCT/IL2021/051551

§ 371 Date: Jun. 28, 2023

Related U.S. Application Data
(60) Provisional application No. 63/131,382, filed on Dec. 29, 2020.

(51) Int. Cl. G06T 7/292; G06V 10/764

(52) U.S. Cl. CPC G06T 7/292; G06V 10/764

(57) ABSTRACT

Al-based computer vision algorithms, operating in the real world rather than in the digital domain, typically operate in a certain three-dimensional space. The system, programs and method provided herein, describe a system that allows limiting the execution of Al algorithms to operate only on objects breaching a predefined and confined plane (also termed grid) or a volume in space. In other words, the system programs and method provided herein define a 2D/2.5D/3D regions or grid in space, operable to detect any change which occurs in and through this grid. This ability includes in certain implementations, the detection of any animate or inanimate object, or multiple grouped objects which may cross, pass or introduced to this grid, their type, identification and action assigning.

### COPYRIGHT NOTICE

A portion of the disclosure herein below contains material that is subject to copyright protection. The copyright owner has no objection to the reproduction by anyone of the patent document or the patent disclosure as it appears in the Patent and Trademark Office patent files or records, but otherwise reserves all copyright rights whatsoever

### BACKGROUND

The disclosure is directed to systems, programs and methods for forming virtual barrier constructs as and their use as a trigger mechanism for additional actions. Specifically, the disclosure is directed to systems and programs for using a set of panels to form a closed or open frame, with sensors to create a 2D/2.5D/3D virtual barrier for detecting object types and their motion direction through and/or within the virtual barrier, which, when coupled to; and/or in communication with other components and modules of the systems, and when coupled to a closed space, such as a cart's basket are used to monitor the content of that space.

The domain of computer vision, especially with regards to Artificial Intelligence (AI), deals mainly with two domains: the physical area where recognition takes place, and the recognition itself. Most of AI-based product and action recognition algorithm focus on the Recognition element.

Under certain circumstances, it is beneficial to couple recognition of various objects using machine vision, assisted by machine learning, with the direction of their motion across various barriers.

These and other challenges of the current state of affairs is addressed in the following description.

### SUMMARY

AI-based computer vision algorithms, operating in the real world rather than in the digital domain, typically operate in a certain three-dimensional space. The system, programs and method provided herein, describe a system that allows limiting the execution of AI algorithms to operate only on objects breaching a predefined and confined plane (also termed grid) or a volume in space. In other words, the system programs and method provided herein define a 2D/2.5D/3D regions or grid in space, operable to detect any change which occurs in and through this grid. This ability includes in certain implementations, the detection of any animate or inanimate object, or multiple grouped objects which may cross, pass or introduced to this grid, their type, identification and action assigning.

Accordingly, and in an exemplary implementation, provided herein is a computerized system for recognizing an object motion through a two/three-dimensional (2D/2.5D/3D) virtual construct, the system comprising: at least one sensor panel (also termed VRG panels), forming an open or closed frame (also termed VRG-frame interchangeably), operable to form the 2D/2.5D/3D virtual construct; the object database; and a central processing module (CPM) in communication with the sensor panels and the object database, the CPM comprising at least one processor and being in communication with a non-volatile memory storage device storing thereon a processor-readable media with a set of executable instructions configured, when executed to cause the at least one processor to perform the step of: using the virtual construct panels, detecting motion of the object through the 2D/2.5D/3D virtual construct and/or detecting the type of the object while passing through the virtual construct.

In another exemplary implementation, provided herein is an article of manufacture comprising a non-transitory memory storage device storing thereon a computer readable medium (CRM) for simultaneous usage of multiple synchronized sensors for detection, the CRM comprising a set of executable instructions configured to, when executed by at least one processor, cause the at least one processor to perform the steps of: simultaneous using a plurality of synchronized sensors in communication with the article of manufacture, detecting motion of the object through and/or within a 2D/2.5D/3D virtual construct.

### BRIEF DESCRIPTION OF THE DRAWINGS

For a better understanding of the systems, programs and methods for using a sensor panel (interchangeable with “VRG-panel”) to create a 2D/2.5D/3D virtual barrier, with regard to the implementations thereof, reference is made to the accompanying examples and figures, in which:

FIG. 1, is a schematic illustrating an exemplary implementation of a VRG panel, with circular ROI's (Region of Interests) ordered in layers in the horizontal and vertical direction;

FIG. 2A, is a schematic illustrating an exemplary implementation of the VRG-frame forming a 2D/2.5D/3D virtual barrier as a component of a self-checkout system, FIG. 2B, being a schematic illustrating an exemplary implementation of the virtual barrier as a component of a self-checkout system operable to accommodate an open shopping cart, with FIG. 2C being a schematic illustrating an exemplary implementation of the VRG-frame forming a 2D/2.5D/3D virtual barrier as a component of a stand-alone, shopping cart unit;

FIG. 3, is a schematic illustrating an exemplary implementation of the VRG frame intended for mounting on a shopping cart's basket and its use;

FIG. 4A, illustrates an exemplary configuration of a trapezoidal-shaped VRG formed by 4 VRG panels with cameras, suitable for mounting on shopping-cart's basket, with FIG. 4B, illustrating a exemplary VRG panel comprising imaging sensors, and FIG. 4C, illustrating another VRG panel comprising imaging sensors, as well as other sensors:

FIGS. 5A, 5B, illustrating exemplary implementations of VRG frame composed of 4 VRG panels forming a closed VRG frame, with sensors positions in the frame corners (5A) and on the panels' centers (5B);

FIG. 6A, illustrating exemplary implementations of VRG frame composed of two opposing panels with 6 cameras in 3×2 configuration operable to capture an object from two sides, with FIG. 6B, illustrating 2 sets of opposing panels, with one panel as a bar; and

FIG. 7 is a schematic illustration of the sub-division of the digital imaging devices (sensors) within the VRG.

### DETAILED DESCRIPTION

The disclosure provides embodiments of systems, programs and methods for using sensor panels to create a 2D/2.5D/3D virtual barrier for detecting motion of objects and products through and/or within the virtual barrier, which, when coupled to; and/or in communication with other components and modules of the systems, are used to identify the objects traversing through the construct.

Limiting the region in space that undergoes continuous recognition algorithms, provides significant improvement to executing such algorithms on every frame regardless of the existence and location of the object in space:
Limiting the execution of algorithms to objects that are positioned in a defined and confined region in space;
Ignoring changes and motions of objects in scope of sensor view but outside of demanded VRG
Reducing power consumption by hardware utilizing the input data for object recognition
Using the same hardware and firmware, increasing accuracy, sensitivity, and precision;
Reducing CPU and GPU requirements; and
Reducing bandwidth requirements both for transmitting captured data, and for controlling any sensor participating in the formation of VRG.

The system and method described hereunder defines a Virtual Recognition Grid (VRG, interchangeable with “2D/2.5D/3D virtual construct”), by creating a virtual area in 3D space, and by monitoring and recognizing objects traversing it (e.g., “breach”). The recognition can be accomplished in two parts namely: recognition of the type or identification of the object or item which gets close to, and/or stays in and/or crosses the VRG: and recognition of a user action and/or action-direction (in other words, detection and recognition of the motion trajectory of the object) being executed by this object or item in and/or through the VRG.

In an exemplary implementation, the VRG sensors are cameras, such as RGB cameras, utilized for capturing an image of the object traversing through the VRG construct. Most existing algorithms for image-based object recognition, such as CNN's (Convolutional neural networks), benefit from having sharp images of the object of interest, i.e. the obtained images are captured with sufficient resolution and minimal motion blur. Typically, packaged goods exhibit graphical information consisting of small details, such as words and textures. Capturing of moving object with sufficient image quality needed to visualize such small details, i.e., capturing sharp images of objects during their motion, may require low exposure times (typically under 4 milliseconds [ms]). Moreover, motion flow algorithms, such as optical-flow and tracking, benefit from sharp images as well since both rely on local matching of pixel masks. Therefore, when using small exposure times, the detection of the direction of the motion of an object through the VRG is improved in terms of accuracy. In addition to having sharp images, the motion flow algorithm benefits from high frame-rates, such as 15 frames per second (fps) or higher. Higher frame rates (>5 fps) lead to smaller displacements of moving objects between consecutive frames, leading to improved motion field accuracies, and in specific algorithms, such as tracking, even faster computation time.

When a camera is utilized in the VRG panel, the camera's focus, depth of field (DOF) and working distance, need to match the dimension of the VRG construct in order to capture shape object images during the object motion through the VRG. In an exemplary implementation, the VRG construct has dimension needed to match the apical opening of a shopping cart, typically a trapezoidal-shaped basket with the long edges (basket length) extending between 60-120 cm, and a width of 30-80. Grocery store carts have variable dimension, that is typically chosen to suit multiple parameters such as, store size, the aisle width, the typical purchase size, (i.e., in terms of the number of groceries), groceries physical size. For example, a small supermarket, as are typically located in dense rural regions, may have small-sized shopping carts with smaller baskets. Such cart will be easier to navigate in narrower aisles but will allow to collect fewer items. Large baskets, as typically present in larger stores, will allow to place larger products such as large economical packages (e.g., 48-roll of toilet paper vs 4-rolls of toilet paper). The selection of the DOF and working distance is made to match the variability of sizes and shapes of the objects passing through the VRG. As an exemplary implementation, a cart basket, having a width of 50 cm, can be mounted by multiple VRG panels, producing a VRG having similar dimensions to the basket apical opening, and with cameras, having DOF of 10-40 cm, when focused to a distance of 20-25 cm.

In certain exemplary implementation the VRG panel may consist of single or multiple light sources, such as LED lights. Adding light sources to the VRG panel, can, in certain implementations, allow to further reduce the cameras' exposure time to smaller durations (e.g. below 3 ms) without the risk of producing too-dark images, yet allowing to increase the image sharpness, by further reducing the motion blur.

Camera's FOV is another aspect for forming a VRG. Selection of the needed FOV angle, is dependent on the target object size needed to be captured by the VRG-panel cameras. For example, capturing a 30 cm wide object traversing through a VRG construct, at a working distance of 25 cm from the VRG camera, requires having a FOV of at least −62° on the relevant width axis of the camera.

Camera's sensor resolution is another important aspect for constructing a VRG panel. Based on the size of the details that need to captured, assuming that the product located within the working distance, the needed sensor resolution can be selected. The VRG's cameras effective resolution (opposed to the number of pixels) can be measured by a resolution target, such as 1951 USAF resolution test chart. Moreover, measuring the cameras modulation transfer function (MTF) is used to identify and characterize a camera and its suitability for a specific VRG panel. MTF is expressed with respect to image resolution (lp/mm) and contrast (%). Correspondingly, a len's geometry contributes to its ability to reproduce good quality image. Lens Diameter (D), Focal Length (f) and f # all affect MTF, through the formula f #=f/D. Where f/# is the light gathering ability of a lens of diameter D and focal length f.

In an exemplary implementation, the VRG is constructed by at least two sensors panels (also termed VRG-panels) and by one or more processing modules. The sensor panels define the coverage area of the VRG by confining the area between the panels. The object or objects which are detected by the VRG-sensors is processed by the processing modules in order to recognize the object type, and in order to analyzes its motion.

Accordingly, and in an exemplary implementation, provided herein is a computerized system for recognizing an object motion through a three-dimensional (or 2D/2.5D/3D) virtual construct, the system comprising: a sensor array operable to form the 3D virtual construct; the object database; and a central processing module (CPM) in communication with the sensor panels and the object database, the CPM comprising at least one processor and being in communication with a non-volatile memory storage device storing thereon a processor-readable media with a set of executable instructions configured, when executed to cause the at least one processor to perform the step of: using the sensor panel, detecting motion of the object through the 3D virtual construct, and/or the object type.

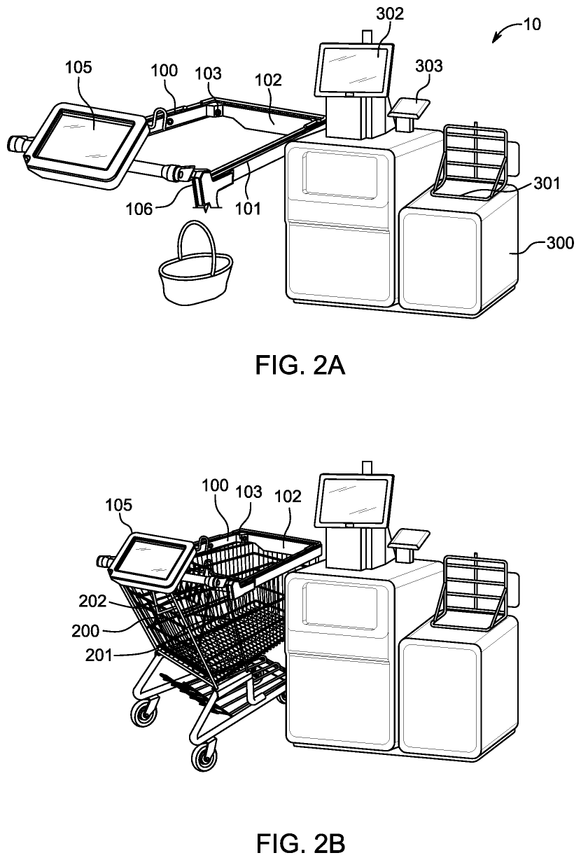

In an exemplary implementation, A VRG is constructed by at least two sensor panels, defining a plane extending between the panels, thus forming the VRG-frame and the virtual construct. Similarly, a VRG can be produced by three or more sensor panels positioned on approximately the same plane in space. In FIG. 2A, 2B the VRG is constructed by 4 panels forming a rectangular shape, where the VRG is the plane/volume confined by the panels. A VRG panel can include sensors, such as RGB cameras and proximity sensors. In some embodiments the VRG panels can include light sources such as LED lights providing additional lighting to the plane which can improve image quality while acquiring images of objects passing through the VRG frame.

In an exemplary implementation the VRG is confined by a closed frame consisting essentially of four (4) or more panels. The VRG can be defined as the volume confined by the VRG panels including the volume located above or below the frame.

Similarly, in another exemplary implementation, the 4 panels form an open frame, i.e. the panels which consist the frame are not necessarily connected in a continuous manner. Thus, forming a an open-frame VRG. Similarly, some panels can be interconnected and some not, still forming a confined region in space defining the VRG construct.

In another exemplary implementation the VRG can be generated by a single, closed or open, continuous sensor panel where the sensors are mounted within the panel but in opposite directions (i.e. the panel is bent to form a shape which allow sensors to observe the opposite region in the panel)

As indicated, the 3D virtual construct (the VRG/VRG-frame) is formed by at least two VRG panels. In certain exemplary implementation, the VRG can be split into two or more parallel virtual planes (or layers) that are used to, effectively, define the 3D virtual measurement construct with a certain associated thickness (i.e., a “virtual slab”). In the context of the disclosure, the term “slab” may be defined as a subset of a volume. The slice, which the virtual 3D construct is comprised of may have parallel sides. Furthermore, Images derived by the processors from objects' motion through and or within the VRG frame, would contain information about the objects intersecting the VRG, rather than the entire 3D volume as captured by the VRG sensors and/or cameras, which are coupled to the VRG panel, whether it is an open cart (see e.g., FIG. 2B), or a self-checkout system (see e.g., FIG. 2A). In the context of the disclosure, the term “frame” does not necessarily mean a continuous polygonal (e.g., triangular, quadrilateral, pentagonal, hexagonal etc.) structure, but refer to the plane formed by at least two panel, having at least one sensor on one panel, operable focus on a portion of the other pane, thereby forming a VRG plane.

In an exemplary implementation, upon detecting of motion of the object through the VRG, the set of executable instructions is further configured, when executed to cause the at least one processor to perform the step of determining the direction of the object motion through the 3D virtual construct, and upon detecting the direction of object motion through the 3D virtual construct, and using the object database, recognizing the object.

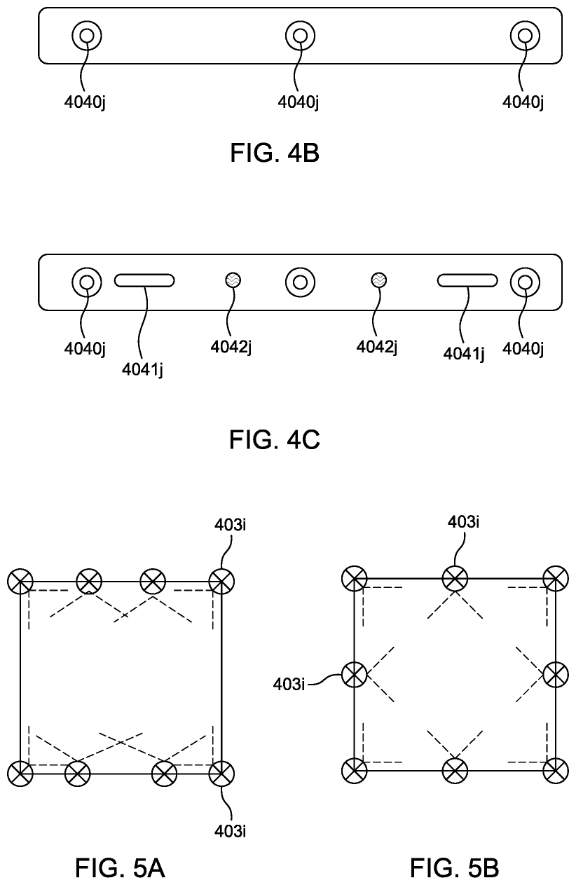

In an exemplary implementation, the sensor used to form the VRG can be an imaging module, comprising, for example, a camera. With this type of sensor, the VRG is constructed by one or more cameras and VRG panels (see e.g., FIG. 4A, 5A, 5B), were their Region of Interest (RoI) is defined as the boundaries of this VRG frame. The VRG is operable to monitor and analyzes the plane or volume it defines continuously. The use of an imaging module, with a plurality of cameras (see e.g., FIG. 4B), with or without additional sensors (see e.g., FIG. 4C), allows the fusion, or stitching of a plurality of images. In an exemplary implementation, a distributed VRG can be constructed using several VRG panels, with or without sensing modules, each comprising, in certain configurations, at least one sensor that has its own processing module, which can contain at least one of: an image signal processor (ISP), a compression engine, a motion detector, a motion direction detector, and an image capturing processor. The module can have a single processor, or each sensor has its own processor that is being further compiled on board the sensor module to provide the necessary output. The distributed imaging/sensing module(s) (e.g., INTEL® REALSENSE™), may work in a synchronous mode, or in an asynchronous mode. Each imaging/sensing module can carry out its own analysis and transmit the data captured within and through the VRG, to a central processing module (CPM), where the captured data can be further processed and provide input to any machine learning algorithms implemented.

Conversely, centrally processed VRG can be comprised of the same imaging/sensing modules, however with a single CPM and without the plurality of processing modules. Central processing allows in certain implementations, an additional level of processing power, such as image preprocessing: user hand and background subtraction, blurry image detection, glare elimination, etc. Moreover, the imaging/sensing modules, in combination with other sensing module are operable in certain implementations to perform at least one of: detecting an object, such as a grocery product or a hand, and trigger an imaging/sensing module, another processor, or another module, whether remote or one forming an integral part of the system.

In certain exemplary implementations, the sensor panel comprises at least one of: at least one camera, a LIDAR emitter and a LIDAR receiver, a LASER emitter and a LASER detector, a magnetic field generator, an acoustic transmitter and an acoustic receiver, and an electromagnetic radiation source. Additionally, or alternatively, the VRG may comprise one or more of the following:
Infrared camera Single or stereo tandem(s)
Heat/temperature sensors (e.g., thermocouples)
Depth (3D) camera (e.g., RGBD)
Hyperspectral/multispectral sensors/cameras,
Ultrasound (or acoustic) sensor—passive and active and
Radar (i.e. electromagnetic) sensor—passive and active

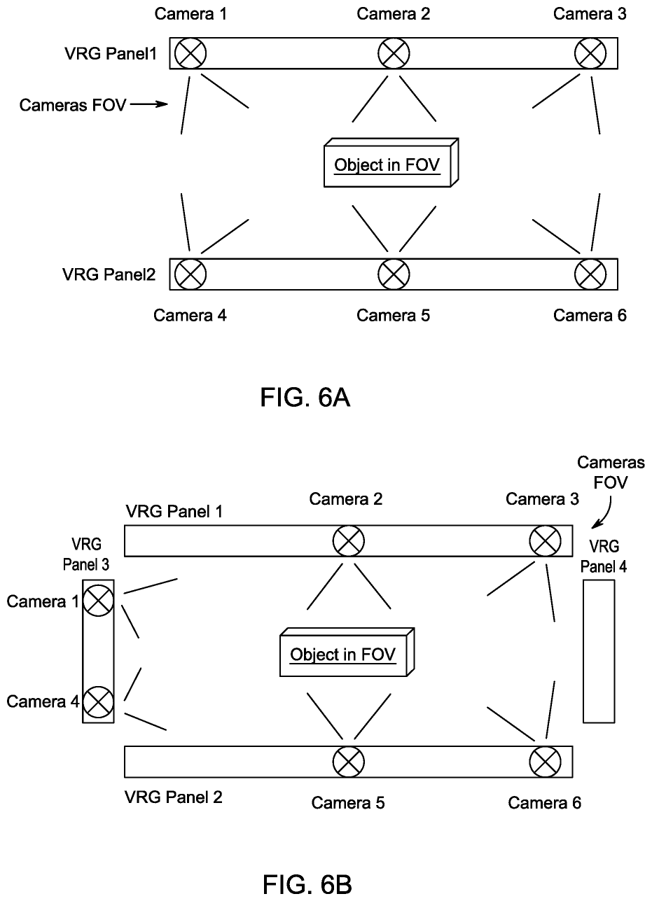

In a specific embodiment a VRG may contain, two or more panels, with at least two cameras located in opposing positions on the VRG, producing intersecting FOV's. When an object is traversing through the VRG, it intersects the two camera's FOV's, allowing simultaneous capturing of the object from two sides. When capturing retail products, such as packaged goods, observing the product from two different sides, i.e. capturing two different facets of that object (see e.g., 600, FIGS. 6A, 6B), improves recognition accuracy of that product. Similarly, having two-pairs, or more, of opposite cameras, allows capturing the products four facets, or 6 or more facets simultaneously. For products that have cylinder-shaped raps, such as bottles, the term facet means capturing different sides, or angles of the object. In such camera configuration, the cameras DOF and working distance need to match the location and size of the objects/products traversing through the VRG, to allow capturing sharp images of both of the products facets/sides. Production of sharp images of the object/product allows to clearly observe the object details, which leads to a significant improvement of the recognition accuracy. As an example, capturing textual information located on a retail-product wrap from two or more sides, by OCR algorithms, leads to improved matching of the textual sequences on that product to a database of textual words from all products in a given store. Similarly, the identification of the object's direction can be improved having multiple views of the same object while traversing through the VRG.

It is noted that the term “imaging/sensing module” as used herein means a unit that includes a plurality of built-in image and/or optic sensors and/or electromagnetic radiation transceivers, and outputs electrical signals, which have been obtained through photoelectric and other EM signal conversion, as an image, while the term “module” refers to software, hardware, and firmware for example, a processor, or a combination thereof that is programmed with instructions for carrying an algorithm or method. The modules described herein may communicate through a wired connection, for example, a hard-wired connections, a local area network, the wirelessly, through cellular communication, or a combination comprising one or more of the foregoing. The imaging/sensing module may comprise cameras selected from charge coupled devices (CCDs), a complimentary metal-oxide semiconductor (CMOS), an RGB camera, an RGB-D camera, a Bayer (or RGGB) based sensor, a hyperspectral/multispectral camera, or a combination comprising one or more of the foregoing. If static images are required, the imaging/sensing module can comprise a digital frame camera, where the field of view (FOV) can be predetermined by, for example, the camera size and the distance from the edge point on the frame. The cameras used in the imaging/sensing modules of the systems and methods disclosed, can be a digital camera. The term “digital camera” refers in an exemplary implementation to a digital still camera, a digital video recorder that can capture a still image of an object and the like. The digital camera can comprise an image capturing unit or module, a capture controlling module, a processing unit (which can be the same or separate from the central processing module). The systems used herein can be computerized systems further comprising a central processing module; a display module; and a user interface module.

Similarly, a magnetic emitter and reflector can be configured to operate in the same manner as the acoustic sensor, using electromagnetic wave pattern instead of acoustic waves. These sensors can use, for example magnetic conductors. Other proximity sensors can be used interchangeably to identify objects penetrating the FOV

In certain implementations, disrupting the pattern created by the signal transmission of the sensor panel indicates a certain object is introduced to the VRG, and the sensors which defines the VRG are triggered. Accordingly, the VRG is triggered in certain exemplary implementations, by any object which may come closer to the VRG, or may cross it. Furthermore, the VRG is operable to determine the direction of the object which gets closer or crosses it. As well as being operable to capture and identify this object. In other words, the VRG performs separate actions, which are combined together to provide the 3D virtual construct's functionality.

In an exemplary implementation, an object close to the VRG without penetrating it, above or below the VRG, can be detected. Since the VRG is defined by a region of intersection of FOV of all sensors virtually forming mentioned VRG, it is important to differentiate between objects that are positioned above or below the VRG, and that will most likely breach the VRG momentarily, from objects in the surrounding background. In case that multiple sensors, such as different cameras, capture the object from different locations it is possible to estimate the object position in 3D space by triangulation algorithms. If the estimated 3D position corresponds to a position above or below the VRG, the system may choose to collect data prior to the VRG breach, which may further help improve specificity and sensitivity of the collected data.

In an exemplary implementation, the sensor panel is coupled to an open frame consisting of at least two VRG panels, operable to provide detection regarding an object traversing the VRG by at least two VRG sensors or panels simultaneously, forming a single-side detection, or two-side detection. As such, the VRG can be constructed as an open solid frame (i.e. with a least to VRG panels), where the VRG is defined as the area bounded by this open frame. Although the open frame is solid, the dimensions covered by the sensors array signals during initiation or calibration phase (i.e. before its use as a VRG). To reiterate, the 3D virtual construct, or the virtual slab (VRG) inside this solid open frame is implemented by one or more pairs of a sensor and its corresponding edge-point, where the sensor (e.g., a LASER transmitter) is located in one side of the frame and edge-point (in other words, a LASER receiver), is located at the opposite side. Together, they cover all or a predetermined part of the 3D virtual construct. or part of the frame, hence, the VRG plane. (in case where one pair does not cover the entire VRG, more pairs are used until the VRG is fully covered).

In other words, provided herein, is a system comprising a sensor panel operable to perform at least one of: be triggered when an object approaches or crosses the VRG, determine the trajectory of the object movement as either: Up or down in a horizontal VRG, Right or left (or forward or backwards) in a vertical VRG, and In or Out in a controlled volume, where VRG is further operable to capture the object representation (for example—its image, or other sensor-specific characteristic), and identifying the product/object.

In certain implementations, the open VRG frame comprising the sensor panels which forms the 3D virtual construct, is coupled to the apical end of an open cart, the cart defining a volume thus forming a horizontal VRG operable to detect insertion and/or extraction of product(s)/object(s) in and out of the given volume A pseudocode showing the breach of the VRG by an object is provided below and detecting insertion and/or extraction in a controlled 3D volume:
1. Start
2. Set state to Clear
3. Clear endpoint (=ROI's) (calibration)
4. Every short period of time, do:
   4.1 Check endpoint (=ROI's)
   4.2 If state is Clear
      4.2.1 If endpoint is clear:
         Go back to (4)
      4.2.2 If endpoint is not clear:
         Declare Breach In
         Change state to Breach
         Go back to (4)
   4.3 If state is Breach
      4.3.1 If endpoint is not clear:
         Go back to (4)
      4.3.2 If endpoint is clear
         Declare Breach Out
         Change state to Clear
         Go back to (4)

Accordingly and in an exemplary implementations, upon recognition of the object, the set of executable instructions is further configured, when executed to cause the at least one processor to perform the steps of: if the motion direction detected is through the 3D virtual construct from the shopping cart outside, identifying an origination location of the object in the open cart; and if the motion direction detected is through the 3D virtual construct from outside the shopping cart inside, identifying a location of the object in the open cart.

For example, two ways that can be implemented to analyze the direction of an object which crosses the VRG are layered detection and one side detection

The following pseudocode assumes double sides VRG:
This VRG is constructed by 2 layers.
(The same concept applies the VRG with n layers as well)
define movement from layer 1 to layer 2 as Moving Right (down).
define movement from layer 2 to layer 1 as Moving Left (up).
1. Start
2. Set state to Clear
3. Clear all endpoint's layers (calibration)
4. Every short period of time, do:
4.1 Check endpoint's layers
4.2 If state is Clear
4.2.1 If both endpoint's layers are clear:
   Go back to (4)
4.2.2 If both endpoint's layers are not clear:
   Declare Breach
   Change state to Breach
   Go back to (4)
4.2.3 If layer 1 is clear and layer 2 is not clear:
   Declare Breach Left
   Change state to Breach Right
   Go back to (4)
4.2.4 If layer 2 is clear and layer 1 is not clear:
   Declare Breach Right
   Change state to Breach Left
   Go back to (4)
4.3 If state is Breach
4.3.1 If both endpoint's layers are not clear:
   Go back to (4)
4.3.2 If both endpoint's layers are clear:
   Declare Clear
   Change state to Clear
   Go back to (4)
4.3.3 If layer 1 is clear and layer 2 is not clear:
   Declare Breach Right
   Change state to Breach Right
   Go back to (4)
4.3.4 If layer 2 is clear and layer 1 is not clear:
   Declare Breach Left
   Change state to Breach Left
   Go back to (4)
4.4 If state is Breach Right
4.4.1 If both endpoint's layers are clear:
   Declare Breach Right
   Change state to Clear
   Go back to (4)
4.4.2 If both endpoint's layers are not clear:
   Declare Breach Left
   Change state to Breach
   Go back to (4)
4.4.3 If layer 1 is clear and layer 2 is not clear:
   Go back to (4)
4.4.4 If layer 2 is clear and layer 1 is not clear:
   Declare Breach Left
   Change state to Breach Left
   Go back to (4)
4.5 If state is Breach Left
4.5.1 If both endpoint's layers are clear:
   Declare Breach Left
   Change state to Clear
   Go back to (4)
4.5.2 If both endpoint's layers are not clear:
   Declare Breach Right
   Change state to Breach
   Go back to (4)
4.5.3 If layer 1 is clear and layer 2 is not clear:
   Declare Breach Right
   Change state to Breach Right
   Go back to (4)
4.5.4 If layer 2 is clear and layer 1 is not clear:
   Go back to (4)

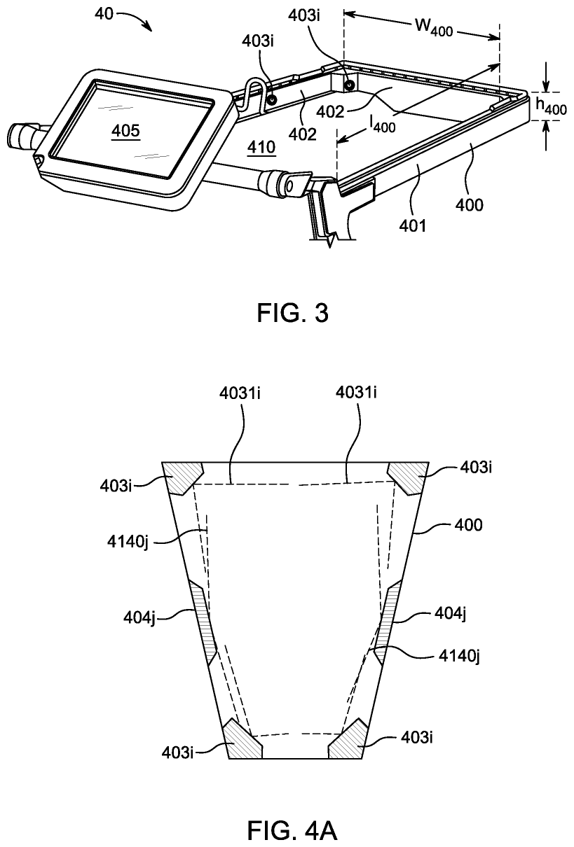

In the context of the disclosure, “one-side-detection” refers to a 3D virtual construct which covers a (controlled) predetermined volume, like an open shopping cart (see e.g., FIGS. 2C, 3). In a controlled volume, layers' definition may be optional in the edge-point (depending e.g., on the size of objects potentially inserted). Since there is no way for an object to cross the VRG from the controlled volume outside (inside-out), without first breaching the VRG with a hand, or another implement, any object which crossing the VRG, ostensibly would come from outside in thus triggering the VRG, and the direction of its movement, is outside-in. Extracting objects/products from the controlled predetermined volume occurs in reverse order: whereby an object blocking the VRG moves to the point it no longer breaches the VRG. Upon loss of a breach, the VRG is triggered and direction is inside-out. As indicated, in an open shopping cart, the only way for an object to move outside is by a hand (or another similarly effective implement), which grabs it. In that case, the hand blocks the VRG while grabbing the object in order to move it outside and could be detected by the proper sensor(s) (e.g., Active IR, hyperspectral/multi-spectral camera, each or both which can be included in the sensor array).

The following insertion/extraction pseudocode assumes the VRG covers a predetermined volume:
1. Start
2. Set ar_state to Clear
3. Wait for trigger to change:
3.1 If ar_state is Clear
3.1.1 If trigger was changed from Breach to Clear
   Go back to (3)
3.1.2 If trigger was changed from Clear to Breach
   Detect breaching object
3.1.2.1 If breached object is only hand
   Change ar_state to Hand In
   Go back to (3)
3.1.2.2 If breached object is hand with product
   Change ar_state to Hand with Product In
   Go back to (3)
3.2 If ar_state is Hand In
3.2.1 If trigger was changed from Clear to Breach
   Go back to (3)
3.2.2 If trigger was changed from Breach to Clear
   Detect breaching out object
3.2.2.1 If breached out object is only hand
   Declare Hand Only
   Change ar_state to Clear
   Go back to (3)
3.2.2.2 If breached out object is hand with product
   Declare Product Extraction
   Change ar_state to Clear
   Go back to (3)
3.3 If ar_state is Hand with Object In
3.3.1 If trigger was changed from Clear to Breach
   Go back to (3)
3.3.2 If trigger was changed from Breach to Clear
   Detect breaching out object
3.3.2.1 If breached out object is only hand
   Declare Product Insertion
   Change ar_state to Clear
   Go back to (3)
3.3.2.2 If breached out object is hand with product
   Declare Product In-Out (Anomaly)
   Change ar_state to Clear
   Go back to (3)

Regardless of the type of the sensor implemented, the systems and CRM provided cover additional volume on both sides of the VRG. For example, although the camera's ROI is on the opposite side of the open frame, still, the camera field of view (FOV) perceives additional volume on all sides of the VRG and the VRG panels. Accordingly, when an object approaches the VRG it enters into sensors' FOV. The sensor is operable to record data which originates from the surrounding volume adjacent to the VRG at all times, but these records are ignored after a certain, predetermined period. Upon triggering the VRG, these records are reviewed and analyzed. Furthermore, since the sensors covering the open frames capture signals at a rates>1 Hz, (e.g., at 5-90 fps (frame per seconds) in camera), and pulses in active sensors—the velocity of the object can be ascertained and the system and CRM can determine exactly where is its location inside the records. Even if the VRG system is triggered only after the object left the VRG boundaries—like in controlled volume—outside direction. Therefore, whenever the VRG system is triggered, the representation (image) of the object is captured. It is noted that while the breach of the VRG will trigger the system, the images captured will reestablish the whole optical flow of the object from its initial position (whether within the cart if covering an enclosed 3D volume, or the shelf, or in general the original position of the object, to the point of breaching the VRG plane, thus finding the objects' origin as well.

Using the object database, classifying algorithms and the like as described in commonly assigned U.S. application Ser. No. 17/267,843, titled “System and Methods for automatic Detection of Product Insertions and Product Extraction in an open Shopping Cart”, filed on Nov. 2, 2020; and U.S. application Ser. No. 17/267,839, titled “System and Method for Classifier Training and Retrieval from Classifier Database for Large Scale Product Identification”, filed on Feb. 11, 2021, both which are incorporated herein by reference in their entirety, can be used in order to recognize the product.

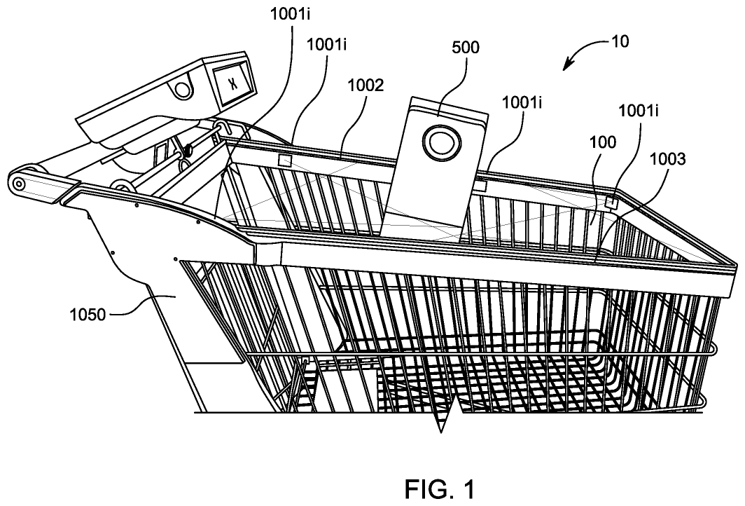

In an exemplary configuration, and as illustrated in FIG. 1, the 3D (2.5D) VRG panel 100 system 10, is formed in an exemplary implementation by the field of view overlap of sensors 1001i disposed on at least two panels 1002, 1003 located on the apical end of shopping cart 1050. Although illustrated as a horizontal VRG, in certain exemplary implementations, the panel is coupled vertically to a refrigerator's opening, or to a single shelf in the refrigerator, or for that matter, any open structure.

Turning now to FIGS. 2A, 2B, and 2C illustrating schematics of exemplary implementations of the 3D (2.5D) virtual construct 100 as a component of self-checkout system 300, with FIG. 2B, being a schematic illustrating an exemplary implementation of the 3D (2.5D) virtual construct 100 as a component of self-checkout system 300, whereby open cart 200 is coupled to virtual construct 100. As illustrated in FIGS. 2A, 2B 3D (2.5D) virtual construct 100 can be coupled to self-checkout system 300. 3D (2.5D) virtual construct can comprise open frame 101, having internal surface 102, and a plurality of sensors 103, operably coupled to internal surface 102 of rigid frame 101. Also illustrated is user interface 105, operable to enable user interaction with the system implementing the CRM disclosed. Self-checkout system may further comprise weigh scale 301, self-checkout user interface 302, and payment module 303. Alternatively, as illustrated in FIG. 2C, Cart 200 can be coupled to virtual construct 100 as an independent assembly, with virtual construct 100 being sized, adapted and configured to operate together with open cart 200 as a stand-alone unit 700.

As further illustrated in FIG. 2B, 3D (2.5D) virtual construct 100 can be coupled to open cart 200, apical rim 202, via, for example complementary surface 106 (see e.g., FIG. 2A), and be operable to cover the whole volume 201 of open cart 200, using plurality of sensors 103.

FIG. 3, illustrates open frame 400, consisting of 4 VRG panels, each panel having an external surface 401 and an internal surface 402, with plurality of sensors 403i operably coupled to internal side 402 of the open frame 400, each having an equivalent field of view and configured to form a virtual construct having dimensions of for example, W₄₀₀×L₄₀₀×h₄₀₀, or as defined by the overlap in the equivalent field of view of all sensors used, for example, by 2, 6, 4, 8, or more digital imaging devices, such as a digital camera, FLIR, and the like.

In the context of the disclosure, the term “user interface” any input means which can be used as a keyboard, a keypad, a pushbutton key set, etc. Additionally, “user interface” broadly refers to any visual, graphical, tactile, audible, sensory, or other means of providing information to and/or receiving information from a user or other entity. For example, a set of instructions which enable presenting a graphical user interface (GUI) on a display module to a user for displaying and changing and or inputting data associated with a data object in data fields. In an exemplary implementation, the user interface module is capable of displaying any data that it reads from the imaging/sensing module.

The Display modules forming a part of the user interface, which can include display elements, which may include any type of element which acts as a display. A typical example is a Liquid Crystal Display (LCD). LCD for example, includes a transparent electrode plate arranged on each side of a liquid crystal. There are however, many other forms of displays, for example OLED displays and Bi-stable displays. New display technologies are also being developed constantly. Therefore, the term display should be interpreted widely and should not be associated with a single display technology. Also, the display module may be mounted on a printed circuit board (PCB) of an electronic device, arranged within a protective housing and the display module is protected from damage by a glass or plastic plate arranged over the display element and attached to the housing.

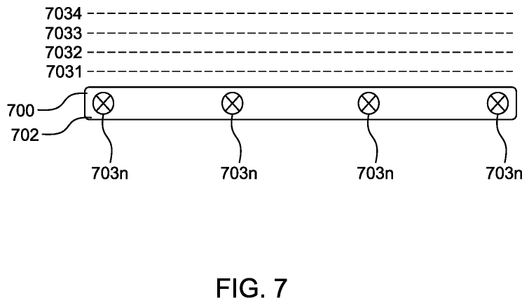

Turning now to FIGS. 4A-4C, and FIG. 7. FIG. 4A, illustrating an exemplary configuration of the virtual construct 400 consisting of 4 VRG panels with various sensors' modules sensors' array as an open frame 400 coupled to open cart 200, having sensors 403i, and 404j with FOV 4031i and 4140j, configured to fully cover the confined region formed between the sensor panels. Although shown as a trapezoid, the system can be used with any polygonal opening, or circular or ovoid openings as well. In other words, the opening shape is immaterial to the operation of the VRG.

In an exemplary implementation, the frame 400 in FIG. 4A, has 4 panels, 2 long panels 406, 406′ and 2 shorter ones 408, 408′, suitable for forming a trapezoidal-shaped VRG frame suitable for mounting on a shopping cart. The VRG frame, has 6 cameras (403i and 404j) located at the 4 corners (403i) and 2 in the middle of the long panels (404j), having FOV's (4031i) and (4140j) respectively. The cameras FOV's (4031i, 4140j) can overlap, providing multiple point-of-views of the objects traversing through the VRG frame.

In an exemplary implementation, the frame 400 in FIG. 4A, has dimensions of a shopping cart's basket. Most cart's has dimensions of 60-120 [cm] along the long edges, and dimension of 30-80 [cm] on the shorter edges, where typically one of the short edges is shorter than the other, forming the typical trapezoidal-shaped apical basket opening. These dimensions support easy insertion of most retail/grocery products (e.g. with dimensions of 3-45 cm) into the cart's basket. When inserting a product through the VRG in FIG. 4A with, i.e., with the 6 cameras (403i and 404j) as described in previous paragraph, the angle of views for any object inserted near the middle of the basket is captured at a minimal incident angle of 45° (at 90° is the product facet is perpendicular to camera's axis). Such angles are needed to allow to observe the fine-details located on the product wrap, at any object/product orientation, which are needed for accurate object recognition. Thus, providing the ability to monitor the content of the shopping basket with high accuracy.

FIG. 4B, in turn illustrating an exemplary configuration of 3 RGB/RGBD cameras 4040j, located along various positions on a VRG panel, and FIG. 4C, illustrating another sensing module comprising RGB/RGBD camera 4040j, as well as other sensors, for example, acoustic transceiver 4041j, and IR active transmitter 4042j.

Turning now to FIG. 7, illustrating an arrangement of 4 digital imaging modules 703n disposed on the internal 702 side of panel 700. In an exemplary implementation, each imaging module's 703n field of view 7030, is striated and sub divided to several decision layers, where detection of product 500 trajectory in each layer, is then associated with a system operation. Accordingly, detection of product 500 trajectory through e.g., layer 7034, a stable top layer, will for example alert (wake-up, conserving processor power and battery power) the system on an incoming product 500 (see e.g., FIG. 1), or end the operation of removing a product from the cart (or any other enclosed space such as a refrigerator, or refrigerator's shelf) on an outgoing product. Likewise, detection of product 500 trajectory through e.g., layer 7033, the stable bottom, will for example trigger the system to communicate with the product database and initiate product classification of an incoming product 500 (see e.g., FIG. 1), or in another example, update the sum of the bill on an outgoing product. Similarly, detection of product 500 trajectory through e.g., layer 7032, a removal VRG layer, will trigger the system to recalculate the bill on contents in a shopping cart, or, for example, in a refrigerator equipped with a load cell shelving, initiate a calculation determining what was removed, and the amount used in bulk or liquid products. Also, detection of product 500 trajectory through e.g., layer 7031, the insertion VRG layer, can for example, trigger the classification of the product, update the list of items and so on. It is noted that the number of striations and sub-layers can change and their designation and associated operation can be different. In an exemplary implementation, the sensors used in the systems disclosed, is an imaging module, operable to provide a field of view, wherein the field of view is sub-divided to a plurality of layers, whereby each layer is associated with at least one of: activation of the processor, activation of an executable instruction, and an activation of a system component (e.g., a sensor).

It is noted that the term “imaging module” as used herein means a panel that includes a plurality of built-in image and/or optic sensors and outputs electrical signals, which have been obtained through photoelectric conversion, as an image, while the term “module” refers to software, hardware, for example, a processor, or a combination thereof that is programmed with instructions for carrying an algorithm or method. The modules described herein may communicate through a wired connection, for example, a hard-wired connection, a local area network, or the modules may communicate wirelessly. The imaging module may comprise charge coupled devices (CCDs), a complimentary metal-oxide semiconductor (CMOS) or a combination comprising one or more of the foregoing. If static images are required, the imaging module can comprise a digital frame camera, where the field of view (FOV) can be predetermined by, for example, the camera size and the distance from the product. The cameras used in the imaging modules of the systems and methods disclosed, can be a digital camera. The term “digital camera” refers in an exemplary implementation to a digital still camera, a digital video recorder that can capture a still image of an object and the like. The digital camera can comprise an image capturing unit or module, a capture controlling module, a processing unit (which can be the same or separate from the central processing module).

Capturing the image can be done with, for example image capturing means such as a CCD solid image capturing device of the full-frame transfer type, and/or a CMOS-type solid image capturing device, or their combination. Furthermore, and in another exemplary implementation, imaging module can have a single optical (e.g., passive) sensor having known distortion and intrinsic properties, obtained for example, through a process of calibration. These distortion and intrinsic properties are, for example, modulation-transfer function (MTF), pinhole camera model attributes such as: principle point location, focal-length for both axes, pixel-size and pixel fill factor (fraction of the optic sensor's pixel area that collects light that can be converted to current), lens distortion coefficients (e.g., pincushion distortion, barrel distortion), sensor distortion (e.g., pixel-to-pixel on the chip), anisotropic modulation transfer functions, space-variant impulse response(s) due to discrete sensor elements and insufficient optical low-pass filtering, horizontal line jitter and scaling factors due to mismatch of sensor-shift- and analog-to-digital-conversion-clock (e.g., digitizer sampling), noise, and their combination. In an exemplary implementation, determining these distortion and intrinsic properties is used to establish an accurate sensor model, which can be used for calibration algorithm to be implemented

FIGS. 5A, 5B illustrate imaging module configuration in VRG full frame where the use of multiple digital imaging devices (e.g., cameras) create capturing of images of the objects 500 (see e.g., FIG. 1) from two or more sides (e.g., front and back, or opposite sides), where each point in the open frame (whether horizontal or vertical or any angle in between), is captured by at least one camera. Alternatively, and as illustrated in FIG. 5B, the configuration provides the camera configuration is operable to cover each point in the VRG by at least two cameras. Similarly, FIG. 6A illustrates an exemplary implementation where two opposing panels 406, 406′ are equipped with three pairs of cameras, 4040j, with FOV 4031j adapted to cover the entirety of 2/2.5/3D virtual construct 60 defined solely by the two panels 406, 406′ such that object 600 when moving through (or in) virtual construct 60, will be captured at least on two sides (interchangeable with facets, or aspect). In yet another exemplary implementation, as illustrated in FIG. 6B, virtual construct 60, is defined by two pairs of opposing panels 406, 406′, and 408, 408′ whereby panels 406, 406′ are equipped with two pairs of cameras 4040j, with FOV 4031j adapted to cover a portion of 2/2.5/3D virtual construct 60 defined by two pairs of opposing panels 406, 406′, and 408, 408′ with panel 408 equipped with two cameras 4040j, trained (focused) on panel 408′ that does not contain any cameras but serves as a bar and focusing target for cameras 4040j coupled to panel 408, with FOV 4031j adapted to cover a different portion of 2/2.5/3D virtual construct 60 than the one covered by the two pairs of cameras 4040j coupled to opposing panels 406, 406′. Using this configuration, object 600 can be captured in certain implementations from three sides. Capturing the image from multiple facets is beneficial in certain to accelerate the detection and classification of object 600, as well as determine its position, both initial and final.

The various appearances of “one example,” “an exemplary implementation”, “an exemplary configuration” or “certain circumstances” do not necessarily all refer to the same implementation or operational configurations. Although various features of the invention may be described in the context of a single example or implementation, the features may also be provided separately or in any suitable combination. Conversely, although the invention may be described herein in the context of separate embodiments for clarity, the invention may also be implemented in a single embodiment. Also, reference in the specification to “an exemplary implementation”, means that a particular feature, structure, step, operation, application, or characteristic described in connection with the examples is included in at least one implementation, but not necessarily in all. It is understood that the phraseology and terminology employed herein is not to be construed as limiting and are provided as background or examples useful for understanding the invention.

In addition, the term ‘module’, as used herein, means, but is not limited to, a software or hardware component, such as a Field Programmable Gate-Array (FPGA) or Application-Specific Integrated Circuit (ASIC), which performs certain tasks. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

As indicated, provided herein is a computer program, comprising program code means for carrying out the steps of the methods described herein, implementable in the systems provided, as well as a computer program product (e.g., a micro-controller) comprising program code means stored on a medium that can be read by a computer, such as a hard disk, CD-ROM, DVD, USB, SSD, memory stick, or a storage medium that can be accessed via a data network, such as the Internet or Intranet, when the computer program product is loaded in the main memory of a computer [or micro-controller] and is carried out by the computer [or micro controller]. Memory device as used in the methods, programs and systems described herein can be any of various types of memory devices or storage devices.

Accordingly and in an exemplary implementation, provided herein is an article of manufacture comprising a non-transitory memory storage device storing thereon a computer readable medium (CRM) for recognizing an object motion through a three-dimensional (3D) virtual construct, the CRM comprising a set of executable instructions configured to, when executed by at least one processor, cause the at least one processor to perform the steps of: using a sensor in communication with the article of manufacture, detecting motion of the object through and/or within the 3D virtual construct, and detect the object/s type.

The term “memory storage device” is intended to encompass an installation medium, e.g., a CD-ROM, SSD, or tape device; a computer system memory or random access memory such as DRAM, DDR RAM, SRAM, EDO RAM, Rambus RAM, etc.; or a non-volatile memory such as a magnetic media, e.g., a hard drive, optical storage, or ROM, EPROM, FLASH, SSD, etc. The memory device may comprise other types of memory as well, or combinations thereof. In addition, the memory medium may be located in a first computer in which the programs are executed, and/or may be located in a second different computer [or micro controller] which connects to the first computer over a network, such as the Internet [or, they might be even not connected and information will be transferred using USB]. In the latter instance, the second computer may further provide program instructions to the first computer for execution. The building blocks of this method shall become more perceptible when presented in the drawings of the flowcharts.

Further, upon detecting of motion of the object through the 3D (2.5D) virtual construct, the set of executable instructions stored on the CRM is further configured, when executed, to cause the at least one processor to perform the step of: determining the direction of the object motion through the 3D virtual construct, as well as using the object database in communication with the article of manufacture, recognizing the objects in motion through or within the 3D (2.5D) virtual construct. Furthermore, upon recognition of the object, the set of executable instructions is further configured, when executed to cause the at least one processor to perform the steps of: if the motion direction detected is through the 3D virtual construct from the open cart outside, identifying an origination location of the object in the open cart; and if the motion direction detected is through the 3D virtual construct from outside the open cart inside, identifying a location of the object in the open cart.

Unless specifically stated otherwise, as apparent from the description, it is appreciated that throughout the specification discussions utilizing terms such as “processing,” “loading,” “in communication,” “detecting,” “calculating,” “determining”, “analyzing,” “presenting”, “retrieving” or the like, refer to the action and/or processes of a computer or computing system, or similar electronic computing device, that manipulate and/or transform data represented as physical, such as the captured and acquired image of the product inserted into the cart (or removed) into other data similarly represented as series of numerical values, such as the transformed data.

Accordingly and in an exemplary implementation, provided herein is a computerized system for recognizing an object motion through a three-dimensional (3D) virtual construct, the system comprising:

At least two panels, each consisting of at least one sensor operable to form the 3D virtual construct; the object's database; and a central processing module (CPM) in communication with the panel's sensors and the object database, the CPM comprising at least one processor and being in communication with a non-volatile memory storage device storing thereon a processor-readable media with a set of executable instructions configured, when executed to cause the at least one processor to perform the step of: using the at least two panel sensors, detecting motion of the object through the 3D virtual construct, wherein (i) the 3D virtual construct forms a 2.5D or 3D slab-shaped region, (ii) whereupon detecting of motion of the object through the 3D virtual construct, the set of executable instructions is further configured, when executed to cause the at least one processor to perform the step of: determining the trajectory of the object motion through the 3D virtual construct, (iii) and using the object database, recognizing the object, wherein (iv) wherein the each of the at least two panel's at least one sensor comprises at least one of: a plurality of cameras; a LIDAR emitter and a LIDAR receiver; a LASER emitter and a LASER detector; a magnetic field generator; an acoustic transmitter and an acoustic receiver; and an electromagnetic radiation source, wherein (v) the panel's sensor is coupled to an open frame, operable to provide a single-side detection, or a two-side detection, (vi) the open frame is coupled horizontally to at least one of: the apical end of an open cart, a self-checkout system, and vertically to a refrigerator opening, or to a refrigerator's shelf opening, whereupon (vii) recognition of the object, the set of executable instructions is further configured, when executed to cause the at least one processor to perform the step of: if the motion trajectory detected is through the 3D virtual construct from the at least one of: the apical end of an open cart, the self-checkout system, and the refrigerator opening, or the refrigerator's shelf opening, to the outside, identifying an origination location of the object in the shopping cart; and if the motion trajectory detected is through the 3D virtual construct from outside the at least one of: the apical end of an open cart, the self-checkout system, and the refrigerator opening, or the refrigerator's shelf opening, to the inside, identifying a location of the object in the at least one of: the open cart, the refrigerator, or the refrigerator's shelf, (viii) and wherein, each of the panels comprises a sensor operable to capture an image of the object; and the set of executable instructions is further configured, when executed to cause the at least one processor to perform the step of: capturing an image of the object from at least two different sides.

In another exemplary implementation, provided herein is an article of manufacture comprising a non-transitory memory storage device storing thereon a computer readable medium (CRM) for recognizing an object motion through a three-dimensional (3D) virtual construct, the CRM comprising a set of executable instructions configured to, when executed by at least one processor, cause the at least one processor to perform the steps of: using a panel's sensor in communication with the article of manufacture, detecting motion of the object through and/or within the 3D virtual construct, wherein (ix) the 3D virtual construct forms a 2.5D or 3D slab-shaped region, whereupon detecting a motion of the object through the 3D virtual construct, the set of executable instructions is further configured, when executed, to cause the at least one processor to perform the step of (x): determining the trajectory of the object motion through the 3D virtual construct, (xi) using an object database in communication with the article of manufacture, recognizing the object, wherein (xii) the sensor array comprises at least one of: a plurality of cameras; a LIDAR emitter and a LIDAR receiver; a LASER emitter and a LASER detector; a magnetic field generator; an acoustic transmitter and an acoustic receiver; and an electromagnetic radiation source, the sensor array (xiii) comprising at least six sensors, wherein the sensors are each a camera and wherein the VRG is defined by the overlap of the at least six camera's field of view, wherein (xiv) the panel's sensor is coupled to an open frame, operable to provide single-side detection, or two-side detection, wherein (xv) the open frame is coupled horizontally to at least one of: the apical end of an open cart, a self-checkout system, and vertically to a refrigerator opening, or to a refrigerator's shelf opening, and whereupon (xvi) recognition of the object, the set of executable instructions is further configured, when executed to cause the at least one processor to perform the step of: if the motion trajectory detected is through the 3D virtual construct from the at least one of: the apical end of an open cart, the self-checkout system, and the refrigerator opening, or the refrigerator's shelf opening, to the outside, identifying an origination location of the object in the shopping cart; and if the motion trajectory detected is through the 3D virtual construct from outside the at least one of: the apical end of an open cart, the self-checkout system, and the refrigerator opening, or the refrigerator's shelf opening, to the inside, identifying a location of the object in the at least one of: the open cart, the refrigerator, or the refrigerator's.

In yet another exemplary implementation, provided herein is an article of manufacture operable to form a three-dimensional (3D) virtual construct, the three-dimensional (3D) virtual construct comprising: At least two panels consisting of at least one sensor operable to form the 3D virtual construct; and a central processing module (CPM) in communication with the panel's sensors, the CPM comprising at least one processor and being in communication with a non-volatile memory storage device storing thereon a processor-readable media with a set of executable instructions configured, when executed to cause the at least one processor to perform the step of: using the panel sensors, detecting motion of an object through the 3D virtual construct, wherein (xvii) wherein the panel's sensors comprises at least one of: a plurality of cameras; a LIDAR emitter and a LIDAR receiver; a LASER emitter and a LASER detector; a magnetic field generator; an acoustic transmitter and an acoustic receiver; and an electromagnetic radiation source, (xviii) the 3D virtual construct forms a 2.5D or 3D slab-shaped region, (xix) comprising four (4) panels consisting of at least one sensor operable to form a closed-frame 3D virtual construct, or (xx) comprising a plurality of cameras, operable upon a breach of a plane formed by the 3D virtual construct by an object, to capture an image of the breaching object from at least two (2) angles, or (xxi) comprising at least six cameras, and wherein the 3D virtual construct is defined by the overlap of the at least six cameras' field of view.

While the invention has been described in detail and with reference to specific exemplary implementations and configurations thereof, it will be apparent to one of ordinary skill in the art that various changes and modifications can be made therein without departing from the spirit and scope thereof. Accordingly, it is intended that the present disclosure covers the modifications and variations of this invention provided they come within the scope of the appended claims and their equivalents.

What is claimed:

1. A computerized system for recognizing an object motion through a three-dimensional (3D) virtual construct, the system comprising:
a) At least two panels, each consisting of at least one sensor operable to form the 3D virtual construct;
b) the object's database; and
c) a central processing module (CPM) in communication with the panel's sensors and the object database, the CPM comprising at least one processor and being in communication with a non-volatile memory storage device storing thereon a processor-readable media with a set of executable instructions configured, when executed to cause the at least one processor to perform the step of: using the at least two panel sensors, detecting motion of the object through the 3D virtual construct.

2. The system of claim 1, wherein the 3D virtual construct forms a 2.5D or 3D slab-shaped region.

3. The system of claim 2, whereupon detecting of motion of the object through the 3D virtual construct, the set of executable instructions is further configured, when executed to cause the at least one processor to perform the step of: determining the trajectory of the object motion through the 3D virtual construct.

4. The system of claim 3, whereupon detecting the trajectory of object motion through the 3D virtual construct, the set of executable instructions is further configured, when executed to cause the at least one processor to perform the step of: using the object database, recognizing the object.

5. The system of claim 2, wherein the each of the at least two panel's at least one sensor comprises at least one of:
a) a plurality of cameras;
b) a LIDAR emitter and a LIDAR receiver;
c) a LASER emitter and a LASER detector;
d) a magnetic field generator;
e) an acoustic transmitter and an acoustic receiver; and
f) an electromagnetic radiation source.

6. The system of claim 5, wherein the panel's sensor is coupled to an open frame, operable to provide single-side detection, or two-side detection.

7. The system of claim 6, wherein the open frame is coupled horizontally to at least one of:
the apical end of an open cart, a self-checkout system, and vertically to a refrigerator opening, or to a refrigerator's shelf opening.

8. The system of claim 7, whereupon recognition of the object, the set of executable instructions is further configured, when executed to cause the at least one processor to perform the step of:
a) if the motion trajectory detected is through the 3D virtual construct from the at least one of: the apical end of an open cart, the self-checkout system, and the refrigerator opening, or the refrigerator's shelf opening, to the outside, identifying an origination location of the object in the shopping cart; and
b) if the motion trajectory detected is through the 3D virtual construct from outside the at least one of: the apical end of an open cart, the self-checkout system, and the refrigerator opening, or the refrigerator's shelf opening, to the inside, identifying a location of the object in the at least one of: the open cart, the refrigerator, or the refrigerator's.

9. The system of claim 4, wherein:
a) each of the panels comprises a sensor operable to capture an image of the object; and
b) the set of executable instructions is further configured, when executed to cause the at least one processor to perform the step of: capturing an image of the object from at least two different sides.

10. An article of manufacture comprising a non-transitory memory storage device storing thereon a computer readable medium (CRM) for recognizing an object motion through a three-dimensional (3D) virtual construct, the CRM comprising a set of executable instructions configured to, when executed by at least one processor, cause the at least one processor to perform the steps of: using a panel's sensor in communication with the article of manufacture, detecting motion of the object through and/or within the 3D virtual construct.

11. The CRM of claim 12, wherein the 3D virtual construct forms a 2.5D or 3D slab-shaped region.

12. The CRM of claim 13, whereupon detecting a motion of the object through the 3D virtual construct, the set of executable instructions is further configured, when executed, to cause the at least one processor to perform the step of: determining the trajectory of the object motion through the 3D virtual construct.

13. The CRM of claim 14, whereupon detecting the trajectory of object motion through the 3D virtual construct, the set of executable instructions is further configured, when executed, to cause the at least one processor to perform the step of: using an object database in communication with the article of manufacture, recognizing the object.

14. The CRM of claim 12, wherein the sensor array comprises at least one of:
a) a plurality of cameras;
b) a LIDAR emitter and a LIDAR receiver;
c) a LASER emitter and a LASER detector;
d) a magnetic field generator;
e) an acoustic transmitter and an acoustic receiver; and
f) an electromagnetic radiation source.

15. The CRM of claim 14, comprising at least six sensors, wherein the sensors are each a camera and wherein the VRG is defined by the overlap of the at least six camera's field of view.

16. The system of claim 14, wherein the panel's sensor is coupled to an open frame, operable to provide single-side detection, or two-side detection.

17. The CRM of claim 16, wherein the open frame is coupled horizontally to at least one of:
the apical end of an open cart, a self-checkout system, and vertically to a refrigerator opening, or to a refrigerator's shelf opening.

18. The CRM of claim 17, whereupon recognition of the object, the set of executable instructions is further configured, when executed to cause the at least one processor to perform the step of:
a) if the motion trajectory detected is through the 3D virtual construct from the at least one of: the apical end of an open cart, the self-checkout system, and the refrigerator opening, or the refrigerator's shelf opening, to the outside, identifying an origination location of the object in the shopping cart; and
b) if the motion trajectory detected is through the 3D virtual construct from outside the at least one of: the apical end of an open cart, the self-checkout system, and the refrigerator opening, or the refrigerator's shelf opening, to the inside, identifying a location of the object in the at least one of: the open cart, the refrigerator, or the refrigerator's.

19. An article of manufacture operable to form a three-dimensional (3D) virtual construct, the three-dimensional (3D) virtual construct comprising:
a) At least two panels consisting of at least one sensor operable to form the 3D virtual construct; and
b) a central processing module (CPM) in communication with the panel's sensors, the CPM comprising at least one processor and being in communication with a non-volatile memory storage device storing thereon a processor-readable media with a set of executable instructions configured, when executed to cause the at least one processor to perform the step of: using the panel sensors, detecting motion of an object through the 3D virtual construct.

20. The article of claim 19, wherein the panel's sensors comprises at least one of:
a) a plurality of cameras;
b) a LIDAR emitter and a LIDAR receiver;
c) a LASER emitter and a LASER detector;
d) a magnetic field generator;
e) an acoustic transmitter and an acoustic receiver; and
f) an electromagnetic radiation source.

21. The article of claim 19, wherein the 3D virtual construct forms a 2.5D or 3D slab-shaped region.

22. The article of claim 19, comprising four (4) panels consisting of at least one sensor operable to form a closed-frame 3D virtual construct.

23. The article of claim 22, comprising a plurality of cameras, operable upon a breach of a plane formed by the 3D virtual construct by an object, to capture an image of the breaching object from at least two (2) angles.

24. The article of claim 23, comprising at least six cameras, and wherein the 3D virtual construct is defined by the overlap of the at least six cameras' field of view.
